(19) United States
(12) Patent Application Publication
(10) Pub. No.: US 2014/0318012 A1
(43) Pub. Date: Oct. 30, 2014

(54) PLANT GROWING DEVICE

(71) Applicant: Panasonic Corporation, Osaka (JP)

(72) Inventor: Hiromitsu FUJIYAMA, Hyogo (JP)

(21) Appl. No.: 14/331,483

(22) Filed: Jul. 15, 2014

Related U.S. Application Data
(63) Continuation of application No. PCT/JP2012/007904, filed on Dec. 11, 2012.

(30) Foreign Application Priority Data
Jan. 16, 2012 (JP) 2012-006598
Nov. 15, 2012 (JP) 2012-251562

(51) Int. Cl. A01G 9/02; A01G 31/02

(52) U.S. Cl. CPC A01G 9/02; A01G 31/02
USPC 47/62 R; 47/66.6

(57) ABSTRACT

A plant growing device 1 is provided with a ventilation unit 6 including an intake unit 61 for taking the air into a growing chamber R and an exhaust unit 62 for exhausting the air from the growing chamber R. The ventilation unit 6 operates in either an intake/exhaust mode for taking the air into and exhausting the air from the growing chamber R or a circulation mode in which the air is circulated in the growing chamber R. By switching between these two modes, CO₂ is taken into the growing chamber R and gas concentration, a temperature, and a humidity in the growing chamber R become uniform, leading to an improvement of the growing efficiency of plants P.

### TECHNICAL FIELD

The present invention relates to a plant growing device provided with a growing chamber in which plants are grown.

### BACKGROUND ART

Conventionally, there is a well-known plant growing device provided with a growing chamber in which plants are grown (refer to Patent Document 1, for example). This type of device includes an exhaust port for discharging the air from the growing chamber to the outside, a blower for sending the air toward the exhaust port, an intake port provided in a position opposite to the exhaust port for taking the air from the outside to the growing chamber, and a light source for illuminating the plants. Upon operating the blower, the air is discharged from the exhaust port, a pressure in the growing chamber becomes negative, the air is taken from the intake port into the growing chamber, and as a result, the growing chamber is ventilated.

### PRIOR ART DOCUMENT(S)

### Patent Document(s)

Patent Document 1: Japanese Laid-Open Patent Publication No. 2003-304754

### SUMMARY OF THE INVENTION

### Problems to be Solved by the Invention

However, in the above-mentioned plant growing device, when the blower is not operated, oxygen which is generated by photosynthesis accumulates in an upper region of the growing chamber and carbon dioxide which is heavier than oxygen and necessary for photosynthesis accumulates in a lower region of the growing chamber, so that carbon dioxide does not sufficiently reach leaf of the plants. Thus, photosynthetic efficiency is reduced and growing efficiency of the plants becomes low. Moreover, when the air is not taken from the outside, for example, a temperature or a humidity in the growing chamber becomes non-uniform due to a heat emitted from the light source, and this may negatively affect the growth of the plants. In contrast, when the air is consistently taken from the outside, it becomes difficult to control a temperature in the growing chamber.

The present invention is to solve the above problems, and an object of the present invention is to provide a plant growing device which can improve growing efficiency of a plant.

### Means to Solve the Problem(s)

One aspect of the present invention relates to a plant growing device including a growing chamber for storing a plant and a ventilation unit for taking the air into and discharging the air from the growing chamber, wherein the ventilation unit has an intake unit for taking the air from outside into the growing chamber and an exhaust unit provided in a position opposite to the intake unit for discharging the air from the growing chamber to the outside, the intake unit has an intake port communicated with the outside, an intake damper for opening and closing the intake port, a blower for sending the air derived from the outside through the intake port to the growing chamber, a passage for guiding the air to an upstream side of the blower when the intake damper is closed to circulate the air in the growing chamber, and a circulation damper for opening and closing the passage, the exhaust unit has an exhaust port communicated with the outside and an exhaust damper for opening and closing the exhaust port, and the ventilation unit operates in either an intake/exhaust mode for taking the air into and discharging the air from the growing chamber by opening the intake damper and the exhaust damper and closing the circulation damper, or a circulation mode in which the air is circulated in the growing chamber by closing the intake damper and the exhaust damper and opening the circulation damper.

According to one aspect of the invention, the ventilation unit is controlled so that the intake/exhaust mode and the circulation mode are switched at every predetermined time.

According to one aspect of the invention, the plant growing device further includes a light source provided in the growing chamber for irradiating the plant with light and a human detection sensor for detecting human near the plant growing device, wherein the light source has a white LED for emitting white light and a red LED for emitting red light, and when the human detection sensor detects human, a radiant energy of red light emitted from the red LED is controlled to become half or less of that of white light emitted from the white LED, and when the human detection sensor does not detect human, the radiant energy of the red light is controlled to become half or more of that of the white light.

According to one aspect of the invention, the plant growing device further includes a door provided on at least one side of side surfaces in a direction orthogonal to an air flow direction connecting the intake unit and the exhaust unit to open and close the growing chamber, a light source storage room provided in an upper region of the growing chamber to store the light source, and a waste heat hole communicated with the light source storage room to discharge waste heat generated by the light source to the outside, wherein in the side surface where the door is provided, the waste heat hole is provided in a position masked by the door and thus not to be exposed to the outside when the door is closed.

According to one aspect of the invention, the light source storage room has a slit on at least one end of both ends in the air flow direction for radiating heat generated by the light source to the outside, and the slit and the waste heat hole are connected by a waste heat passage, and the waste heat passage has an orthogonal part connected to the slit and extending in a direction orthogonal to the air flow direction and a parallel part connected to the orthogonal part and extending in a direction parallel to the air flow direction to be connected to the waste heat hole.

According to one aspect of the invention, the plant growing device further includes a cultivation container in which the plant is planted, and a distance between the cultivation container and the light source is adjustable.

According to one aspect of the invention, the cultivation container has a hydroponic tank for growing the plant hydroponically and a bucket located below the hydroponic tank so that the water flows from the hydroponic tank to the bucket, and the plant growing device further includes a pump for pumping the water from the bucket to the hydroponic tank.

According to one aspect of the invention, a maximum water storage capacity of the bucket is larger than that of the hydroponic tank.

According to one aspect of the invention, the plant growing device further includes a water cooling unit for cooling the water supplied to the hydroponic tank to adjust a water temperature.

According to one aspect of the invention, the plant growing device further includes a light-shielding cover covered on an upper surface of the hydroponic tank, wherein the cover has plural insertion ports into which the plant is inserted and a light-shielding caps which are detachably attached to the insertion ports.

According to one aspect of the invention, the cover is fixed to the hydroponic tank by a fixture attached to an inside of the growing chamber.

According to one aspect of the invention, a height from a bottom surface of the hydroponic tank to a lower surface of the insertion ports is substantially the same with a height of a surface of water pooled in the hydroponic tank.

According to one aspect of the invention, the hydroponic tank has a tubular drain passage which passes through a bottom of the hydroponic tank and extends in a vertical direction and a partition plate provided so as to surround an aperture on an upper side of the drain passage, and the partition plate has an upper end higher than the aperture and an opening in a position lower than the aperture.

According to one aspect of the invention, the drain passage is detachable or height-adjustable with respect to the hydroponic tank.

According to one aspect of the invention, the hydroponic tank is placed on a hydroponic tank receiver constituting a bottom surface of the growing chamber, the hydroponic tank receiver has a vertical hole through which the drain passage passes and a groove in which a dew condensation water generated on a surface of the hydroponic tank is pooled, and the groove slopes down toward the vertical hole so that the dew condensation water flows into the vertical hole.

According to one aspect of the invention, the plant growing device further includes a first connection unit for connecting the plural growing chambers arranged horizontally each other, wherein the first connection unit connects the respective growing chambers so that the air flows between one growing chamber and the other growing chamber.

According to one aspect of the invention, the plant growing device further includes a second connection unit for connecting the plural hydroponic tanks arranged vertically each other, wherein the second connection unit connects the respective hydroponic tanks so that the water flows from one hydroponic tank into the other hydroponic tank.

According to one aspect of the invention, the plant growing device further includes a germination room for sprouting a seed of a plant.

According to one aspect of the invention, the plant growing device further includes a memory unit which stores information regarding a switching time of the intake/exhaust mode and the circulation mode, and a ventilation unit controller which controls an operation of the ventilation unit based on the information stored in the memory unit.

According to one aspect of the invention, the information stored in the memory unit is supplied from an external server by an electric communication line.

### Effect of the Invention

According to the present invention, the ventilation unit functions in either the intake/exhaust mode for taking the air into and discharging the air from the growing chamber or the circulation mode in which the air is circulated in the growing chamber. Since the air (carbon dioxide) is taken from the outside to the growing chamber in the intake/exhaust mode and oxygen/carbon dioxide concentration, a temperature, and a humidity in the growing chamber become uniform by circulating the air in the growing chamber in the circulation mode, it is possible to improve the growing efficiency of the plant.

### BRIEF DESCRIPTION OF THE DRAWINGS

FIG. 1 is a perspective view of a plant growing device according to a first preferred embodiment of the present invention.

FIG. 2 is a diagram of the plant growing device in FIG. 1 viewed from A direction of FIG. 1 and its partial enlarged view.

FIG. 3A is a sectional view taken along I-I line of FIG. 2, and FIG. 3B is a sectional view taken along II-II line of FIG. 2.

FIG. 4 is a partial cross-sectional view of the plant growing device in FIG. 1 viewed from B direction of FIG. 1.

FIG. 5 is a diagram of the plant growing device in FIG. 1 viewed from C direction of FIG. 1.

FIG. 6 is a side cross-sectional view of a cultivation container constituting the plant growing device in FIG. 1.

FIG. 7 is a top view of the cultivation container in FIG. 6.

FIG. 8A is a side view of a pump and a water cooling unit constituting the plant growing device in FIG. 1, and FIG. 8B is a front view and its partial enlarged view of the pump and the water cooling unit in FIG. 8A.

FIG. 9 is a diagram of the plant growing device in FIG. 1 taking and discharging air from/to outside into/from the inside of the plant growing device.

FIG. 10 is a diagram of the plant growing device in FIG. 1 circulating air in the inside of the plant growing device.

FIG. 11 is a perspective view of a plant growing device according to a second preferred embodiment of the present invention.

FIG. 12 is a cross-sectional view of the plant growing device in FIG. 11.

FIG. 13A is a top view of a cover constituting the plant growing device in FIG. 11, and FIG. 13B is a sectional view taken along I-I line of FIG. 13A.

FIG. 14 is a top view of a hydroponic tank receiver constituting the plant growing device in FIG. 11.

FIG. 15 is a perspective view showing a layout of a light source and waste heat holes constituting the plant growing device in FIG. 11.

FIG. 16 is a cross-sectional view showing a layout of the light source and the waste heat holes of FIG. 15.

FIG. 17 is a sectional side view of two growing chambers, which constitute the plant growing device in FIG. 11, arranged horizontally and connected to each other using a first connection unit and end units.

FIG. 18 is an exploded perspective view of the first connection unit of FIG. 17.

FIG. 19 is a perspective view showing a connection between the hydroponic tanks using the first connection unit.

FIG. 20 is an exploded perspective view of the end unit in FIG. 17.

FIG. 21 is a sectional side view of the two hydroponic tanks, which constitute the plant growing device in FIG. 11, arranged vertically and connected to each other using a second connection unit and end units.

### DESCRIPTION OF THE PREFERRED EMBODIMENTS

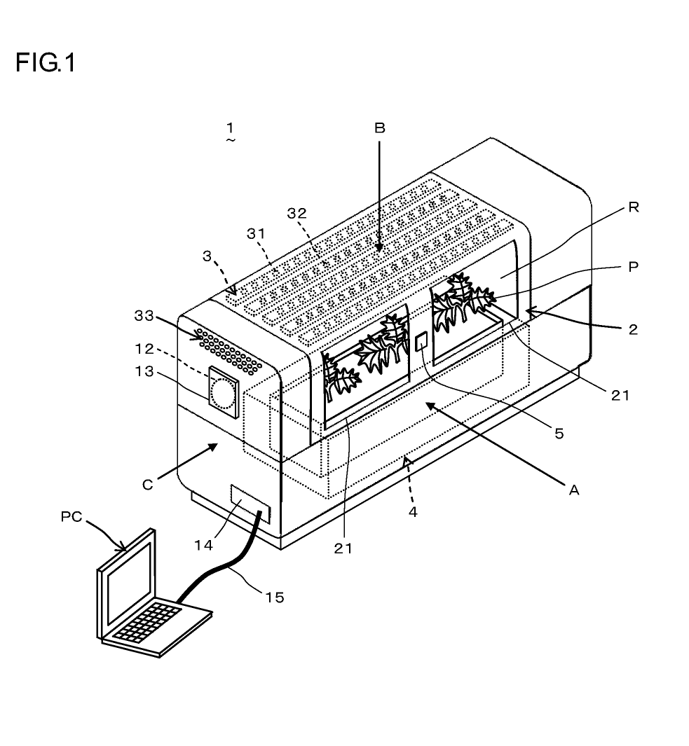

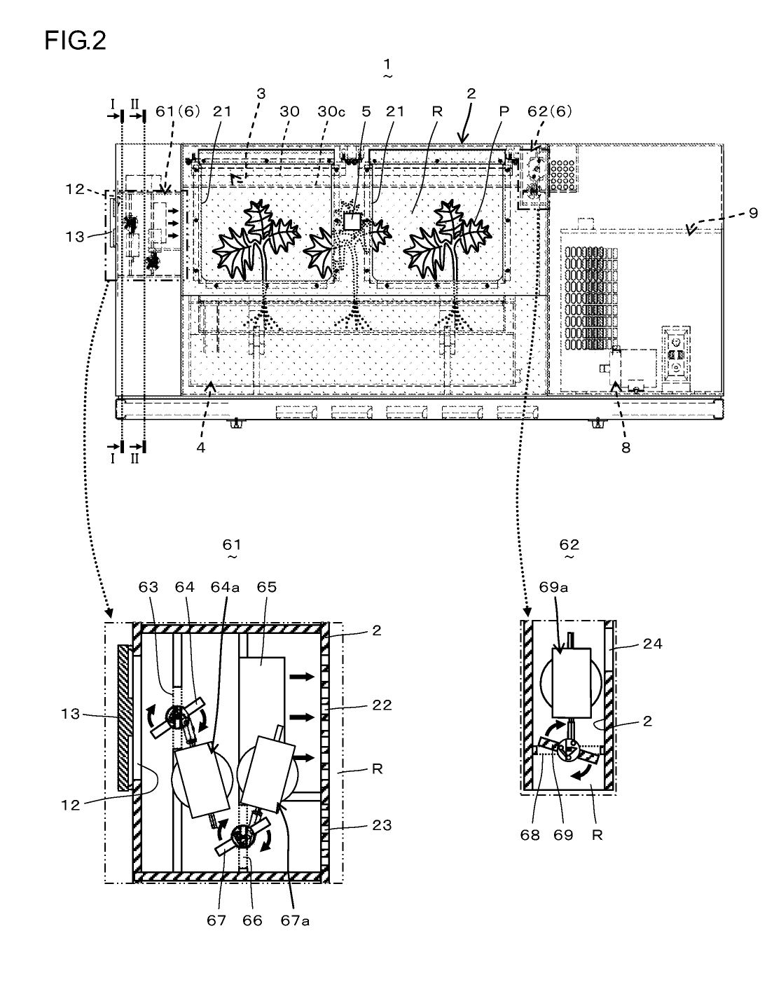

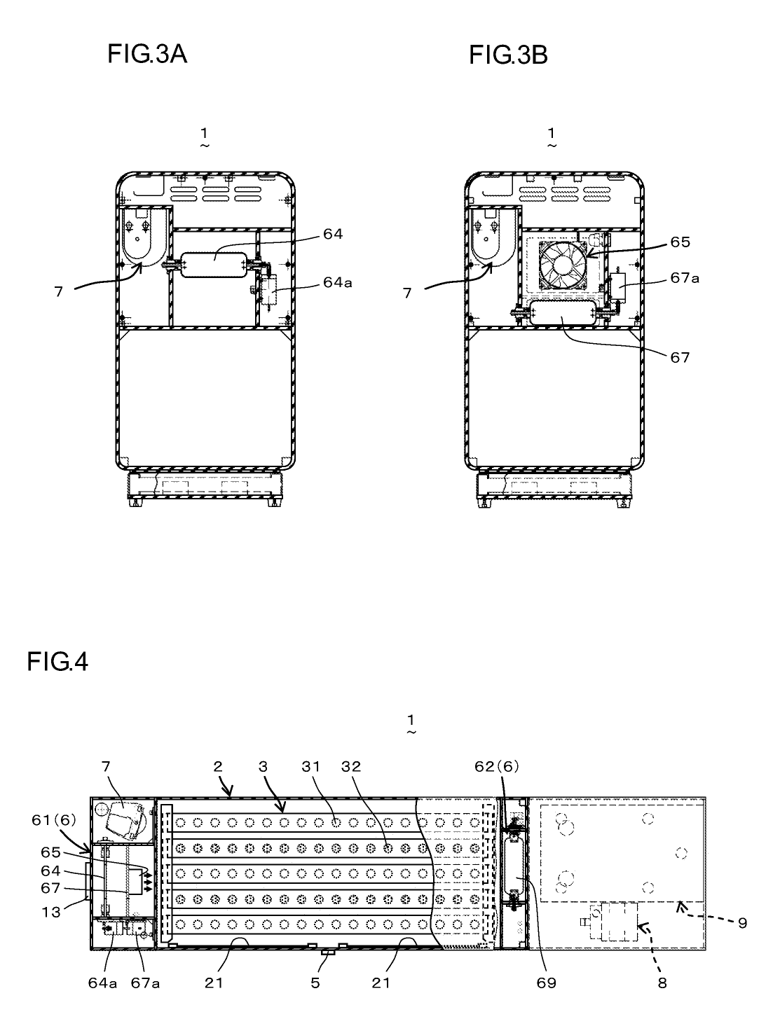

A plant growing device according to a first preferred embodiment of the present invention is described with reference to FIGS. 1 to 8. As shown in FIG. 1, a plant growing device 1 includes a case 2 which has a growing chamber R for storing plants P, a light source 3 which irradiates the plants P, a cultivation container 4 in which the plants P are planted, a human detection sensor 5 which detects human near the plant growing device 1. The case 2 is provided with a transparent door (window) 21 for opening and closing the growing chamber R and the plants P can be seen from the outside of the plant growing device 1. The case 2 is made up of acrylic resin, for example. The light source 3 is stored in a light source storage room 30 (refer to the following FIG. 2 or FIG. 5) provided in an upper region of the growing chamber R. The light source storage room 30 and the growing chamber R are not communicated with each other and separated by a translucent partition member 30c so that the light emitted from the light source 3 is irradiated to the plants P. The light source 3 is made up of plural white light-emitting white LEDs 31 arranged in a line and plural red light-emitting red LEDs 32 arranged in a line. These two LED lines are arranged alternately and repeatedly. The human detection sensor 5 detects human by sensing infrared radiation emitted from human.

The plant growing device 1 also has a waste heat hole 33 communicated with the light source storage room 30 to discharge heat emitted from the light source 3 to the outside, a hole 12 for taking air from the outside to the growing chamber R, and an air filter 13 attached to the hole 12. Moreover, the plant growing device 1 has a LAN jack 14 used for a connection to a personal computer PC, and is connected to the personal computer PC by a LAN cable 15 via the LAN jack 14. The personal computer PC is used for controlling a turning on/off of the light source 3 and an operation of a ventilation unit described below. In addition, the plant growing device 1 has a thermometer for measuring a temperature in the growing chamber R and the outside, and a hygrometer for measuring a humidity in the growing chamber R and the outside.

As shown in FIGS. 2 to 5, the plant growing device 1 further has a ventilation unit 6 for taking air into and discharging air from the growing chamber R, a camera 7 for taking an image of the inside of the growing chamber R, and a pump 8 and a water cooling unit 9 used for growing the plant P hydroponically. The camera 7 is made up of a CCD camera and transmits the image of the plants P to the personal computer PC in real time.

The ventilation unit 6 has an intake unit 61 for taking the air from the outside to the growing chamber R and an exhaust unit 62 provided in a position opposite to the intake unit 61 for discharging the air from the growing chamber R to the outside. The intake unit 61 is provided between the growing chamber R (shown by dots in FIG. 2) and the hole 12, and the exhaust unit 62 is provided in an upper region of the growing chamber R.

The intake unit 61 has an intake port 63 communicated with the outside via the hole 12, an intake damper 64 for opening and closing the intake port 63, and a blower 65 for sending the air derived from the outside through the intake port 63 to a direction of the growing chamber R. The blower 65 is consistently operated through a period during which the plants P are grown. The air sent by the blower 65 goes through plural holes 22 provided in a surface of the case 2 facing the blower 65 and enters the growing chamber R. Moreover, the intake unit 61 has a passage 66 for guiding the air to an upstream of the blower 65 when the intake damper 64 is closed to circulate the air in the growing chamber R, and a circulation damper 67 for opening and closing the passage 66. In the case 2, plural holes 23 are provided in a surface facing the passage 66 so that the air circulating in the growing chamber R goes through the holes 23. The intake damper 64 and the circulation damper 67 are driven to open and close by an intake damper driver 64a and a circulation damper driver 67a, respectively.

The exhaust unit 62 has an exhaust port 68 communicated with the outside and an exhaust damper 69 for opening and closing the exhaust port 68. The exhaust damper 69 is driven to open and close by the exhaust damper driver 69a. The air which reaches to the exhaust unit 62 from the growing chamber R through the exhaust port 68 goes through a hole 24, which is provided in the case 2, to be discharged to the outside.

A ventilation unit controller (not shown) which controls an opening and closing of the intake damper 64, the circulation damper 67, and the exhaust damper 69 is incorporated into the personal computer PC, and functions according to a user's operation on the personal computer PC or a program read in the personal computer PC. The ventilation unit controller opens and closes the intake damper 64 and the exhaust damper 69 synchronously. When the intake damper 64 and the exhaust damper 69 are opened, the circulation damper 67 is closed, and when the intake damper 64 and the exhaust damper 69 are closed, the circulation damper 67 is opened.

The white LED 31 of the light source 3 is used for illuminating the plant P and is made up of, for example, a GaN-based blue light-emitting LED chip covered with a yellow phosphor. As the red LED 32, an LED which emits red light having a peak wavelength around 660 nm is preferably used. Such a red light is efficiently absorbed by phytochrome photoreceptor of the plant P and accelerates the growth of the plant P by activating photosynthesis.

The turning on/off of the light source 3 is controlled by a light source controller (not shown) incorporated into the personal computer PC. The light source controller controls the white LED 31 and the red LED 32 independently. The light source controller is operated in association with the human detection sensor 5, and when the human detection sensor 5 detects human around the plant growing device 1, the light source controller controls a radiant energy of the red light emitted from the red LED 32 to become half or less of that of the white light emitted from the white LED 31. On the other hand, when the human detection sensor 5 does not detect human around the plant growing device 1, the light source controller controls the radiant energy of the red light to become half or more of that of the white light.

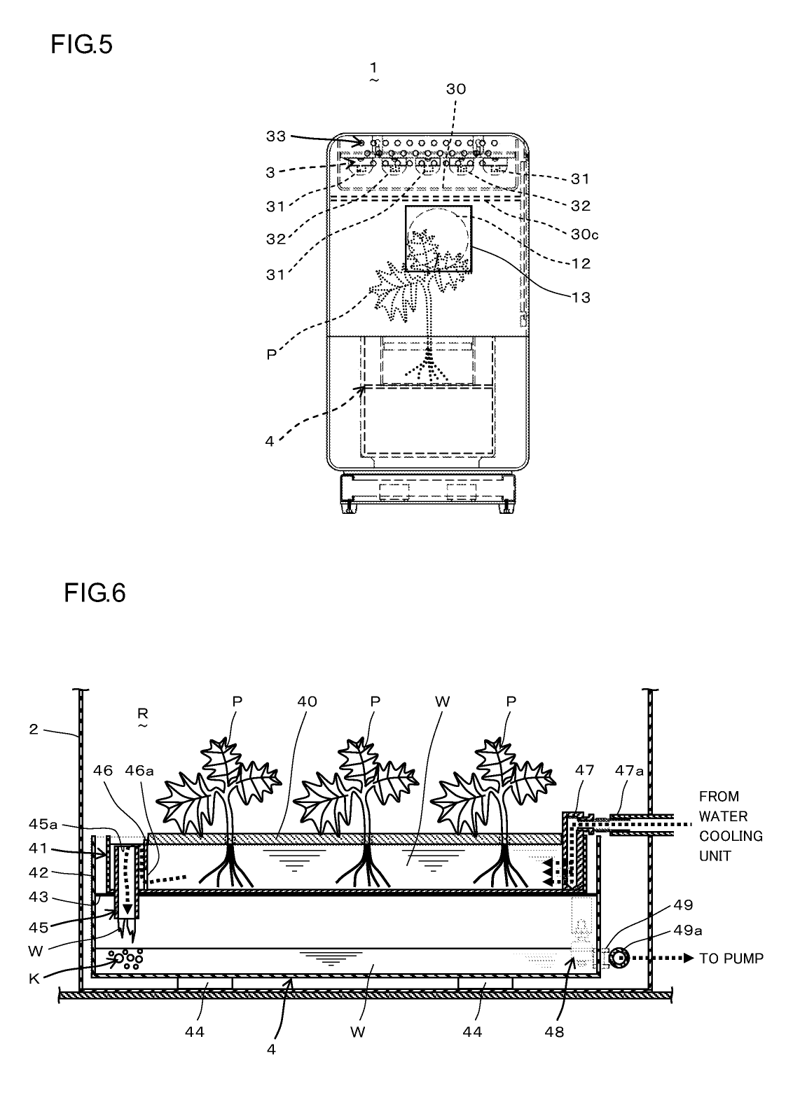

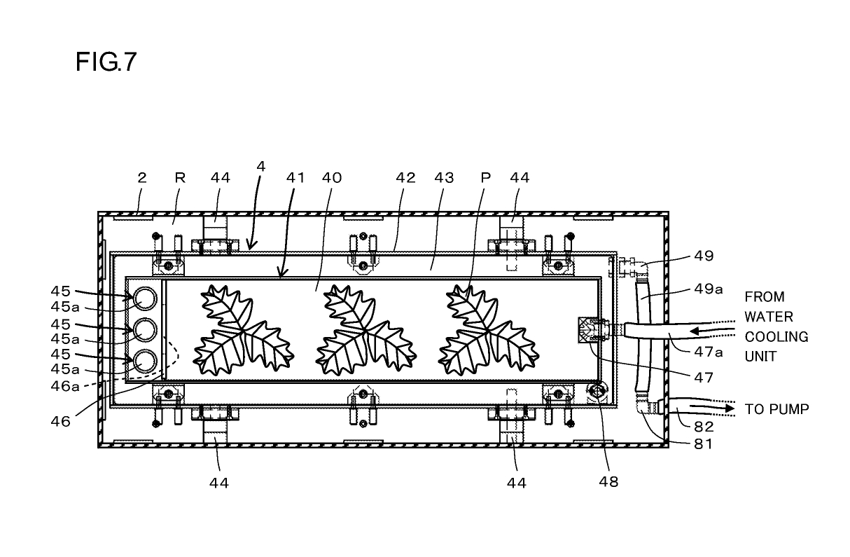

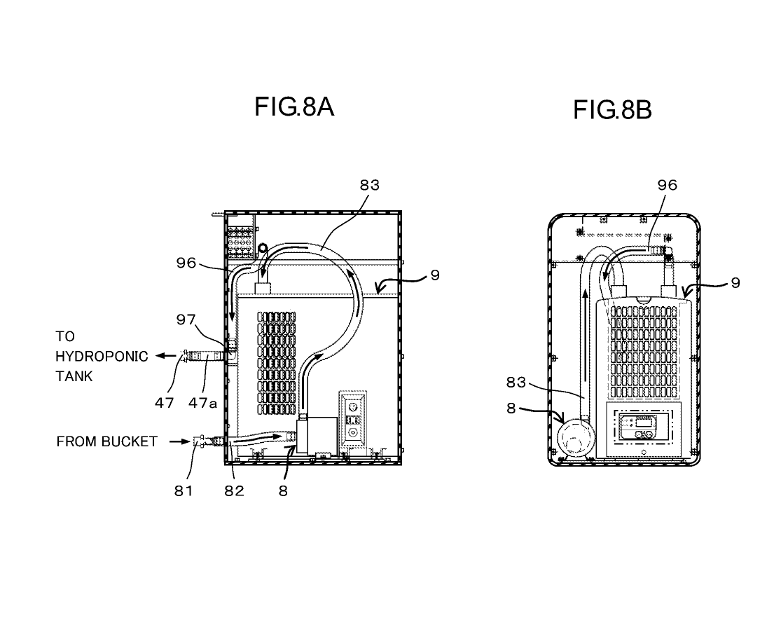

As shown in FIGS. 6 and 7, the cultivation container 4 is provided in the growing chamber R. The cultivation container 4 has a hydroponic tank 41 filled with water W (or nutritious liquid) for hydroponically growing the plants P and a bucket 42 which is located below the hydroponic tank 41 so that the water W from the hydroponic tank 41 flows into the bucket 42. Both of the hydroponic tank 41 and the bucket 42 have a long box shape. The bucket 42 is slightly larger than the hydroponic tank 41 and maximum water storage capacity of the bucket 42 is larger than that of the hydroponic tank 41. The hydroponic tank 41 is stored within the bucket 42 while being placed on a support plate 43 which is horizontally attached inside the bucket 42. Plural spacers 44 are interposed between the bucket 42 and the case 2. A height of each spacer 44 is adjustable, and a distance between the light source 3 and the cultivation container 4 is adjusted by changing the height of each spacer 44. The plants P are inserted in holes provided in a floating plate 40 floated on the water W for cultivation. A heater (not shown) for heating the water W is placed inside the bucket 42 while being always submerged in the water W, and the operations of the heater and the water cooling unit 9 used for cooling the water W (refer to the following FIGS. 8A and 8B) is program-controlled by the personal computer PC.

The hydroponic tank 41 has a tubular drain passage 45 at one end. The drain passage 45 passes through a bottom of the hydroponic tank 41 and extends in a vertical direction. In addition, the hydroponic tank 41 has a partition plate 46 provided so as to surround an aperture 45a on an upper side of the drain passage 45. A space is provided between a lower aperture of the drain passage 45 and a surface of the water W pooled in the bucket 42. The partition plate 46 has an upper end higher than the aperture 45a and an opening 46a in a position lower than the aperture 45a. In addition, the hydroponic tank 41 has a water injection port 47 at the other end used for injecting the water W from the water cooling unit 9. The water injection port 47 and the water cooling unit 9 are connected to each other by a hose 47a.

The water W injected from the water injection port 47 flows toward the drain passage 45, and after passing through the opening 46a of the partition plate 46, flows into the drain passage 45 from the aperture 45a (a path of the water W is shown by dotted arrows in FIG. 6). The water W which flows along the drain passage 45 and flows down to the bucket 42 generates air bubbles K and dissolves oxygen in the water W (aeration), resulting in an improvement of the growing efficiency of the plants P. The quantity of the water W pooled in the bucket 42 is detected by a water level sensor 48. The water W in the bucket 42 is sent to a pump 8 via a connector 49 provided on one side of the bucket 42, a hose 49a attached to the connector 49, a connector 81 attached to the hose 49a, and a hose 82 attached to the connector 81.

As shown in FIGS. 8A and 8B, the pump 8 sends the water from the bucket 42 to the water cooling unit 9 via a hose 83 (the water flow is shown by arrows). The water cooling unit 9 cools the water from the pump 8 and controls the water temperature. The water cooled by the water cooling unit 9 is sent to the water injection port 47 of the hydroponic tank 41 via a hose 96 connected to the water cooling unit 9, a connector 97 attached to the hose 96, and a hose 47a attached to the connector 97.

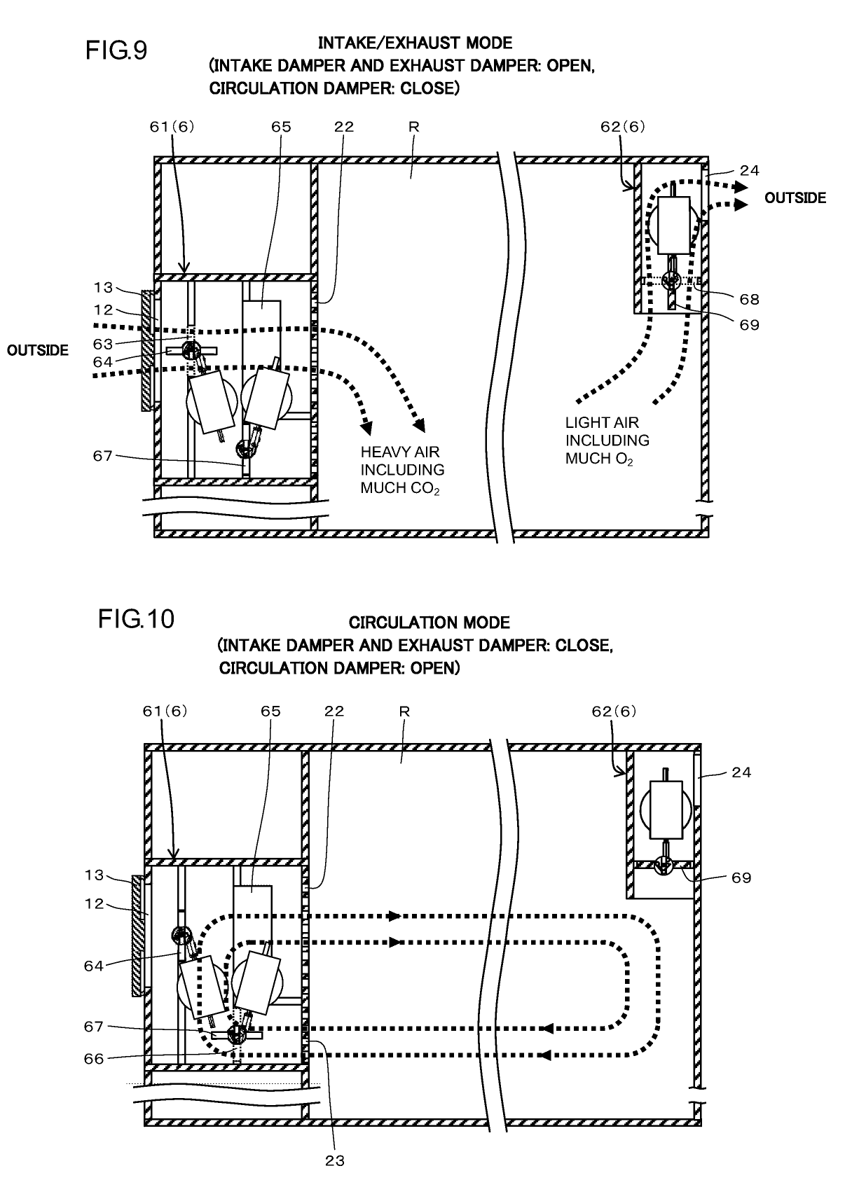

Next, an operation of taking and discharging air from/to the outside into/from the growing chamber R in the plant growing device 1 is described. As shown in FIG. 9, when the air is taken, the ventilation unit 6 opens the intake damper 64 and the exhaust damper 69 and closes the circulation damper 67. Accordingly, the air from the outside enters the intake unit 61 through the hole 12 and the intake port 63, and further is sent toward the growing chamber R by the blower 65 and taken into the growing chamber R through the hole 22 (the air flow is shown by dotted arrows). The air taken from the outside is heavier than the air in the growing chamber R which contains much oxygen (O₂) and less carbon dioxide (CO₂) by photosynthesis of the plant P. Accordingly, the air taken from the outside which includes much CO₂ goes to the bottom of the growing chamber R, and the lighter air including much O₂, which is originally contained in the growing chamber R, is pushed by the air taken from the outside and moves to an upper region of the growing chamber R. The air including much O₂ goes through the exhaust port 68 of the exhaust unit 62 and then is discharged from the hole 24 to the outside. Since the exhaust unit 62 is located at the upper region of the growing chamber R, the light air including much O₂ is preferentially discharged from the growing chamber R.

On the other hand, as shown in FIG. 10, in the case that the air is circulated in the growing chamber R, the ventilation unit 6 closes the intake damper 64 and the exhaust damper 69 and opens the circulation damper 67. Accordingly, the air is sent to the growing chamber R by the blower 65, and thereby the air pushed out from the growing chamber R goes through the hole 23 and the passage 66 and then returns to an upstream of the blower 65, leading to circulation of the air in the growing chamber R.

As described above, the ventilation unit 6 operates in two different modes, that is, the intake/exhaust mode for taking the air into and discharging the air from the growing chamber R or the circulation mode in which the air is circulated in the growing chamber R. These modes are controlled to be switched at every predetermined time. This control is carried out by a memory unit which stores information regarding the mode switching time and the ventilation unit controller which controls an operation of the ventilation unit 6 based on the information stored in the memory unit. Both the memory unit and the ventilation unit controller are incorporated into the personal computer PC. The information regarding to the mode switching time is supplied to the memory unit of the personal computer PC from an external server by an electric communication line (Internet). The external server records various mode switching times optimized for the various types of the plants P as a library. The user selects an appropriate mode switching time from the library and downloads it to the personal computer PC. Accordingly, even when growing a plant P which is never grown, the user can grow the plant P under an optimum condition. Moreover, the mode switching time and a light irradiation pattern of the light source 3 may be changed by a remote control based on an image of the plant P taken by the camera 7.

According to the plant growing device 1 of the present preferred embodiment, the ventilation unit 6 operates in either the intake/exhaust mode or the circulation mode. Thus, the air (carbon dioxide) is taken from the outside to the growing chamber R in the intake/exhaust mode, and oxygen/carbon dioxide concentration, a temperature, and a humidity in the growing chamber R become uniform by circulating the air in the growing chamber R in the circulation mode, leading to efficient growing of the plant P.

In addition, when human is present near the plant growing device 1, the radiant energy of the red light emitted from the red LED 32 is controlled to become half or less of that of the white light emitted from the white LED 31. This prevents the plant P from appearing reddish and thus improves the appearance of the plant P. On the other hand, when human is not present near the plant growing device 1, the radiant energy of the red light emitted from the red LED 32 is controlled to become half or more of that of the white light emitted from the white LED 31. This can improve the growth of the plant P by irradiating more red light from the red LED 32 in comparison with the case that no or less red light is irradiated.

Moreover, since the height of each spacer 44 is adjustable, the distance between the light source 3 and the cultivation container 4 can be changed according to the growth of the plant P. For example, when the plant P is in early developmental stage and is still small, the light source 3 and the cultivation container 4 are brought closer to each other so that the light emitted from the light source 3 is irradiated intensively to the plant P. In contrast, when the plant P grows up and becomes large, the light source 3 and the cultivation container 4 are moved away from each other so that the light emitted from the light source 3 is irradiated widely to the plant P.

Moreover, since the drain passage 45 has the tubular shape extending in the vertical direction, only the water W which overflows from the hydroponic tank 41 is discharged. Therefore, for example, even if injection speed of the water W from the water cooling unit 9 to the hydroponic tank 41 changes, a quantity of the water W pooled in the hydroponic tank 41 can be kept constant. The height of the drain passage 45 is preferably adjusted so that the water W pooled in the hydroponic tank 41 becomes half or less of the maximum capacity of the hydroponic tank 41. Additionally, since the water W passes the opening 46a of the partition plate 46 and then flows into the drain passage 45, dust floating on the surface of the water W in the hydroponic tank 41 is hard to be flowed into the drain passage 45. Accordingly, a drop of the dust into the bucket 42 and a clogging of the pump 8 can be prevented. Here, it is preferable that, for example, a mesh is provided on the aperture 45a of the drain passage 45 to collect the dust and prevent the drop of the dust into the bucket 42 more securely. The drain passage 45 is not limited to have the circle-tubular shape as shown in the drawings, and may have a square-tubular shape, for example.

Furthermore, since the maximum water storage capacity of the bucket 42 is larger than that of the hydroponic tank 41, for example, even when the hydroponic tank 41 is damaged and a water leakage occurs, the leaked water is pooled in the bucket 42 and breakdown of other equipment or the like due to the flood is prevented. Moreover, since the water W has an effect of buffering a temperature change in the growing chamber R, as far as the temperature of the water W is kept constant using the heater and the water cooling unit 9, the temperature in the growing chamber R can be kept almost constant.

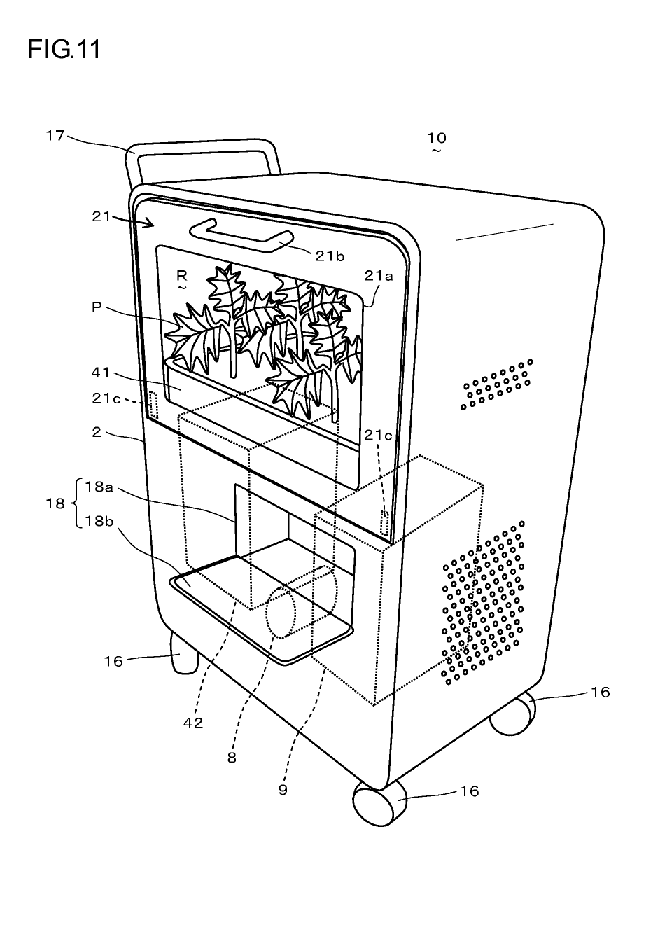

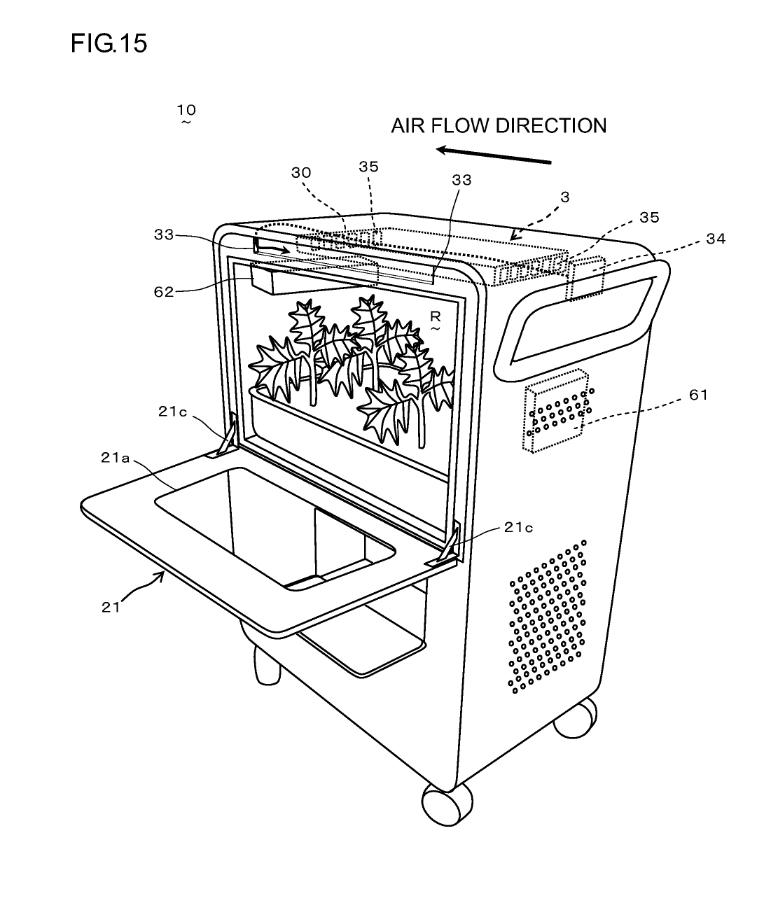

Next, a plant growing device according to a second preferred embodiment of the present invention is described with reference to FIGS. 11 to 16. As shown in FIG. 11, a plant growing device 10 has a rectangular door 21 for opening and closing the growing chamber R, a window 21a provided in the door 21, and a handle 21b used for opening and closing the door 21. The door 21 is connected to the case 2 by hinges 21c provided on both sides of a lower side of the door 21 and can be opened and closed by rotating around the lower side of the door 21 as a rotation axis (also refer to the following FIG. 15). In addition, in the plant growing device 10, the nutritious liquid tank (bucket) 42, the pump 8, and the water cooling unit 9 are located below the hydroponic tank 41. Moreover, the plant growing device 10 has plural casters 16 provided on its bottom surface and a handle 17 provided on its side surface, and can be freely drawable by pulling the handle 17. Furthermore, the plant growing device 10 has a germination room 18 for sprouting a seed of a plant.

The germination room 18 has a concave part 18a provided in one side surface of the plant growing device 10, an opening/closing cover 18b which can open and close to cover the concave part 18a, and a germination room LED (not shown) provided on an upper surface of the concave part 18a. The germination room LED consists of, for example, an LED which emits light of warm white color and is turned on with low luminance for a predetermined period of time. The germination room 18 induces germination of the plant seed under a dark condition in which the germination room LED is turned off or a low light condition in which the germination room LED is turned on. A hose 96 (not shown) connecting the water cooling unit 9 and the hydroponic tank 41 goes across the germination room 18. According to this configuration, since the water whose temperature is controlled by the water cooling unit 9 flows in the hose 96 and the temperature in the germination room 18 is substantially kept constant, leading to efficient germination. A timer for controlling a lighting time of the germination room LED may further be provided to adjust the lighting time of the germination room LED according to a type of seed to be germinated. Moreover, the germination room 18 may also be used as a sprout room for growing a sprout. In this case, a height of a stem of the sprout and nutrients included in the sprout can be controlled to a certain degree by irradiating the sprout at a predetermined period after germination.

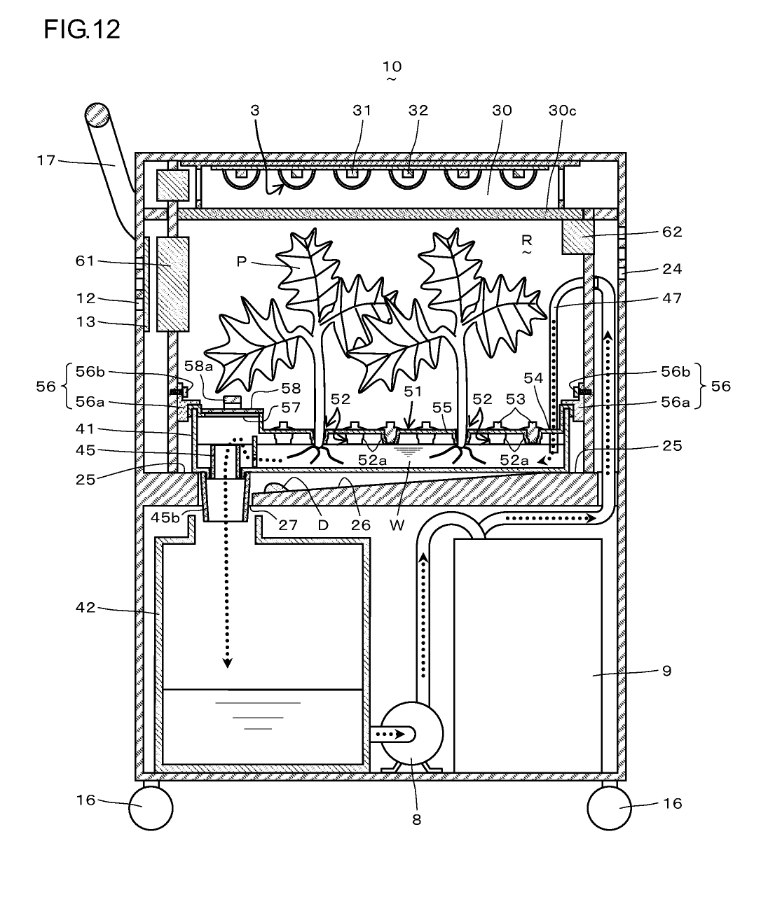

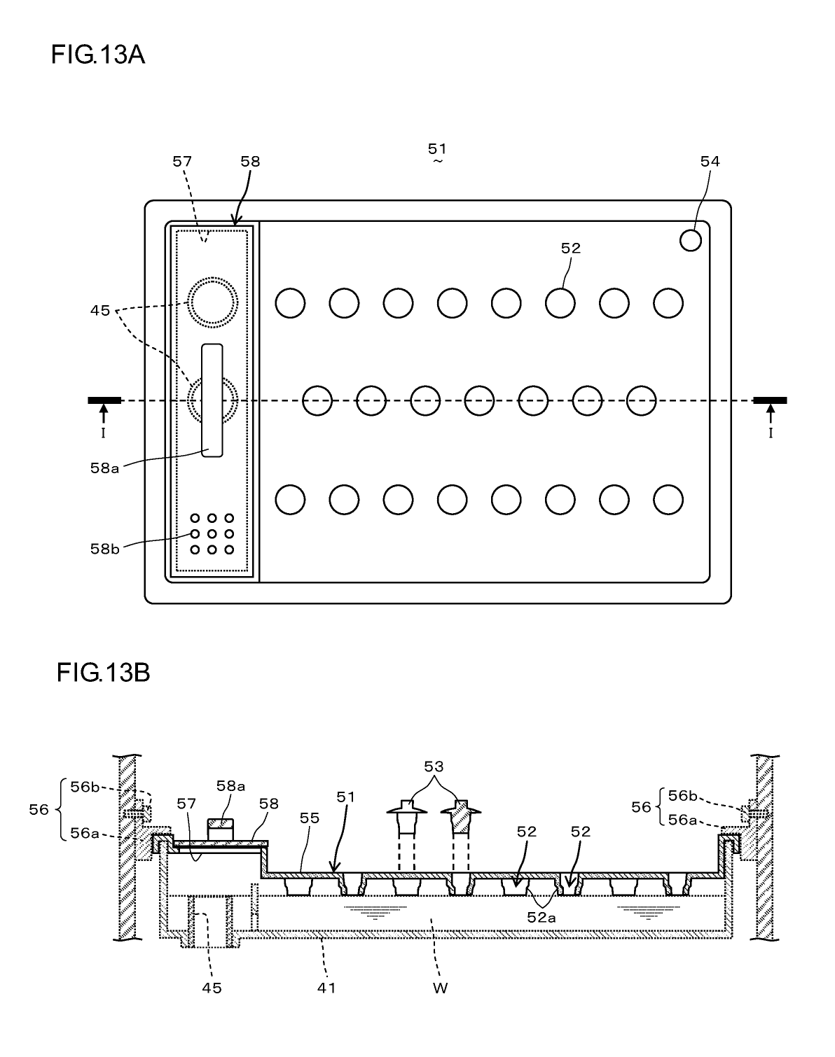

As shown in FIG. 12, in the plant growing device 10, a cover 51 is covered on an upper surface of the hydroponic tank 41. The cover 51 has a light-shielding property and has plural insertion ports 52 into which the plants P are inserted, a light-shielding caps 53 which are detachably attached to the insertion ports 52, and an insertion hole 54 into which the water injection port 47 is inserted (also refer to FIGS. 13A and 13B). When the plant P is grown, the cap 53 is detached and the plant P is inserted into the insertion port 52, and the cap 53 is attached to the insertion port 52 in which the plant P is not inserted. Since the cover 51 and the caps 53 have the light-shielding property, the water W is not irradiated with the light emitted from the light source 3. Consequently, it is possible to prevent an occurrence of algae in the water W and photodecomposition of the nutrients included in the water W.

The plural insertion ports 52 are provided in a lower surface 55 of the cover 51 which is engaged with the hydroponic tank 41, and have a rib 52a extending downward. The lower surface 55 is lowered by one step than an outer edge of the cover 51. A height from a bottom surface of the hydroponic tank 41 to a lower surface of the rib 52a is substantially the same with a height of the surface of the water W pooled in the hydroponic tank 41, that is to say, a height of the drain passage 45. Accordingly, even if the plant growing device 10 is rocked, a rock of the water W can be minimized.

The cover 51 is fixed to the hydroponic tank 41 by a fixture 56 attached to a wall surface of the growing chamber R. In an illustrated example, the fixture 56 has a fixing member 56a which presses the cover 51 to the hydroponic tank 41 from above and a screw 56b which screws the fixing member 56a to the wall surface of the growing chamber R. This configuration prevents the cover 51 from coming off the hydroponic tank 41, so that even when the plant growing device 10 is mobilized using the casters 16 or the plant growing device 10 is rocked in an earthquake, for example, a spill of the water W from the hydroponic tank 41 can be prevented. Moreover, since the cap 53 is attached to the insertion port 52 in which the plant P is not inserted, overflow of the water W from the insertion port 52 can also be prevented.

The cover 51 has an opening 57 provided in a position corresponding to the drain passage 45 and a waste solution cover 58 detachably covered on the opening 57. The waste solution cover 58 has a handle 58a for holding the waste solution cover 58 and air holes 58b (refer to FIG. 13A) used for intake of the air into the water W from the outside. Moreover, the drain passage 45 is detachable or height-adjustable with respect to the hydroponic tank 41. This configuration is achieved, for example, by providing a screw groove on a lower end of outer periphery of the drain passage 45 and a screw hole on the hydroponic tank 41, and screwing the drain passage 45 to the hydroponic tank 41. According to the above configuration, since all of the water W pooled in the hydroponic tank 41 can be discharged by detaching the drain passage 45 from the hydroponic tank 41, it becomes easy to exchange the water W and clean the hydroponic tank 41. Moreover, the height of the surface of the water W can be freely adjusted by adjusting the height of the drain passage 45.

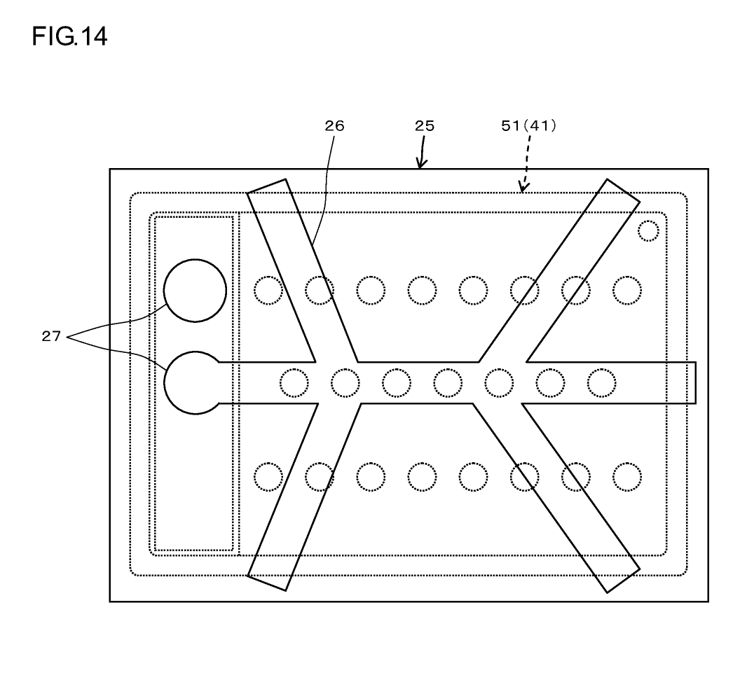

Returning to FIG. 12, in the plant growing device 10, the hydroponic tank 41 is placed on a hydroponic tank receiver 25 constituting a bottom surface of the growing chamber R. The hydroponic tank receiver 25 has a groove 26 in which a dew condensation water D generated on the surface of the hydroponic tank 41 is pooled and a vertical hole 27 through which the drain passage 45 and a pipe 45b surrounding a periphery of the drain passage 45 pass (also refer to FIG. 14). Between the pipe 45b and the vertical hole 27, there is a space which the dew condensation water D can flow down and the nutritious liquid tank 42 is placed below the pipe 45b and the vertical hole 27. Moreover, the groove 26 slopes down toward the vertical hole 27 so that the dew condensation water D flows into the vertical hole 27. According to this configuration, since the dew condensation water D flows down the groove 26 and then drops from the vertical hole 27 into the nutritious liquid tank 42, it is possible to prevent the hydroponic tank receiver 25 from being inundated with the dew condensation water D and thereby prevent an occurrence of algae and a propagation of bacteria on the hydroponic tank receiver 25.

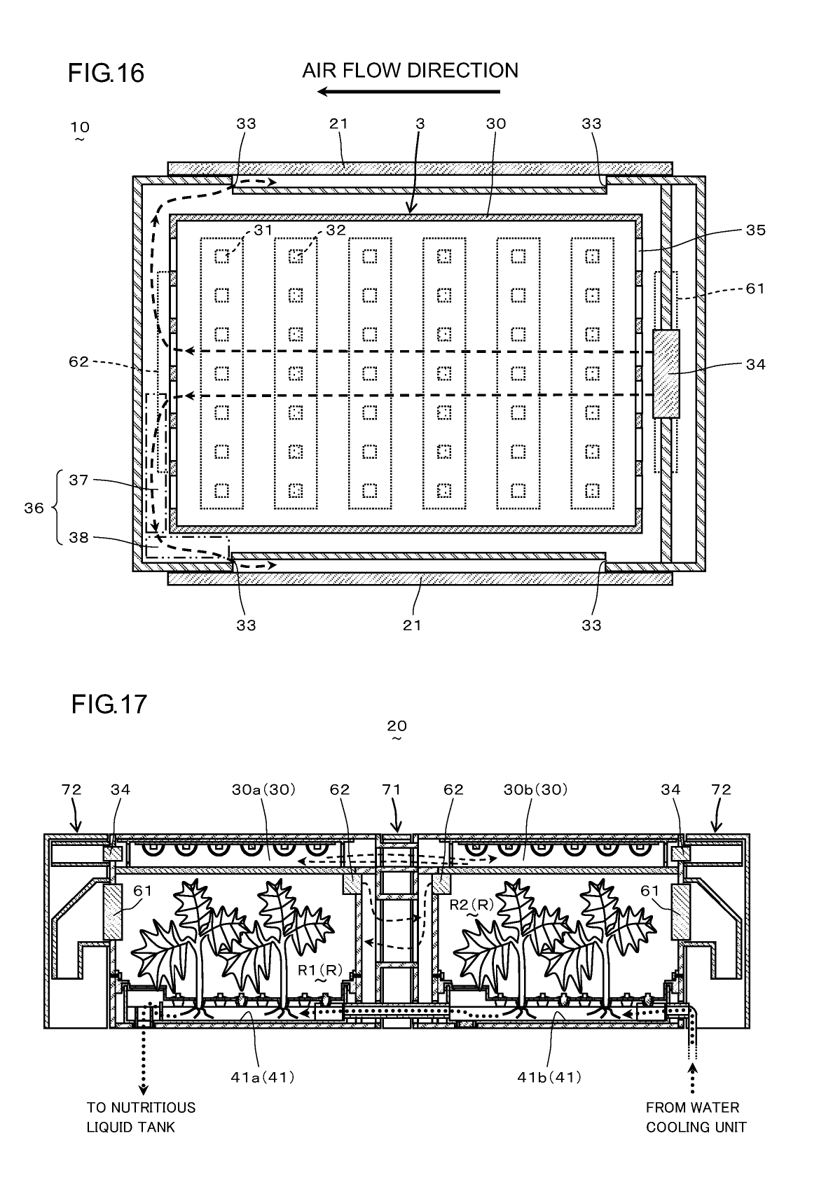

As shown in FIGS. 15 and 16, the plant growing device 10 has a door 21 on at least one side of side surfaces in a direction orthogonal to an air flow direction connecting the intake unit 61 and the exhaust unit 62. Moreover, the plant growing device 10 has the waste heat hole 33 on the side surface in which the door 21 is provided. The waste heat hole 33 is provided in a position masked by the door 21 and thus not to be exposed to the outside when the door 21 is closed, making an appearance of the plant growing device 10 smart.

Moreover, the plant growing device 10 has a light source blower 34 for sending the air to the light source 3. The light source blower 34 is provided on one end in the air flow direction and on a side of the light source 3. The light source 3 has plural slits 35 on both ends in the air flow direction to radiate heat generated by the light source 3 to the outside. A waste heat passage 36 (refer to FIG. 16) connecting the slit 35 and the waste heat hole 33 has an orthogonal part 37 (shown by a dashed line) which is orthogonal to the air flow direction and extending from the slit 35 toward the outside the plant growing device 10 and a parallel part 38 (shown by a double-dashed line) which is connected to the orthogonal part 37 and extending along the air flow direction. Wall surfaces of the orthogonal part 37 and the parallel part 38 is painted in black.

According to the above configuration, the air (shown by dashed arrows in FIG. 16) sent from the light source blower 34 passes through the slit 35, the inside of the light source 3, the orthogonal part 37 and the parallel part 38, and then is discharged outside from the waste heat hole 33. Accompanying with this flow of the air, the heat generated according to the light emission from the LEDs 31 and 32 of the light source 3 is also radiated to the outside. On the other hand, the light emitted from the LEDs 31 and 32 is outputted outside of the light source 3 from the slit 35 and then attenuates during a reflection in the orthogonal part 37 and the parallel part 38 whose wall surfaces are painted in black, so that little light is outputted outside from the waste heat hole 33. Accordingly, it is possible to prevent the light leakage from the waste heat hole 33 and the area of the door 21 around the waste heat hole 33.

Next, horizontal connection of the plural growing chambers R is described with reference to FIGS. 17 to 20. As shown in FIG. 17, a plant growing device 20 has two growing chambers R arranged horizontally and connected to each other using a first connection unit 71. The two growing chambers R are arranged so that each of the exhaust units 62-provided side surface faces each other. Hereinafter, in order to distinguish the two growing chambers R, the growing chamber R located on the left is referred to as a growing chamber R1 and the growing chamber R located on the right is referred to as a growing chamber R2.

The first connection unit 71 connects the growing chambers R1 and R2 so that the air flows between the growing chambers R1 and R2. Moreover, the first connection unit 71 connects a light source storage room 30a in the growing chamber R1 and a light source storage room 30b in the growing chamber R2, and connects a hydroponic tank 41a in the growing chamber R1 and a hydroponic tank 41b in the growing chamber R2 so that the water flows from the hydroponic tank 41b to the hydroponic tank 41a. Moreover, an end unit 72 for masking the intake unit 61 and the light source blower 34 is provided on each end part located opposite to the side where the first connection units 71 are provided.

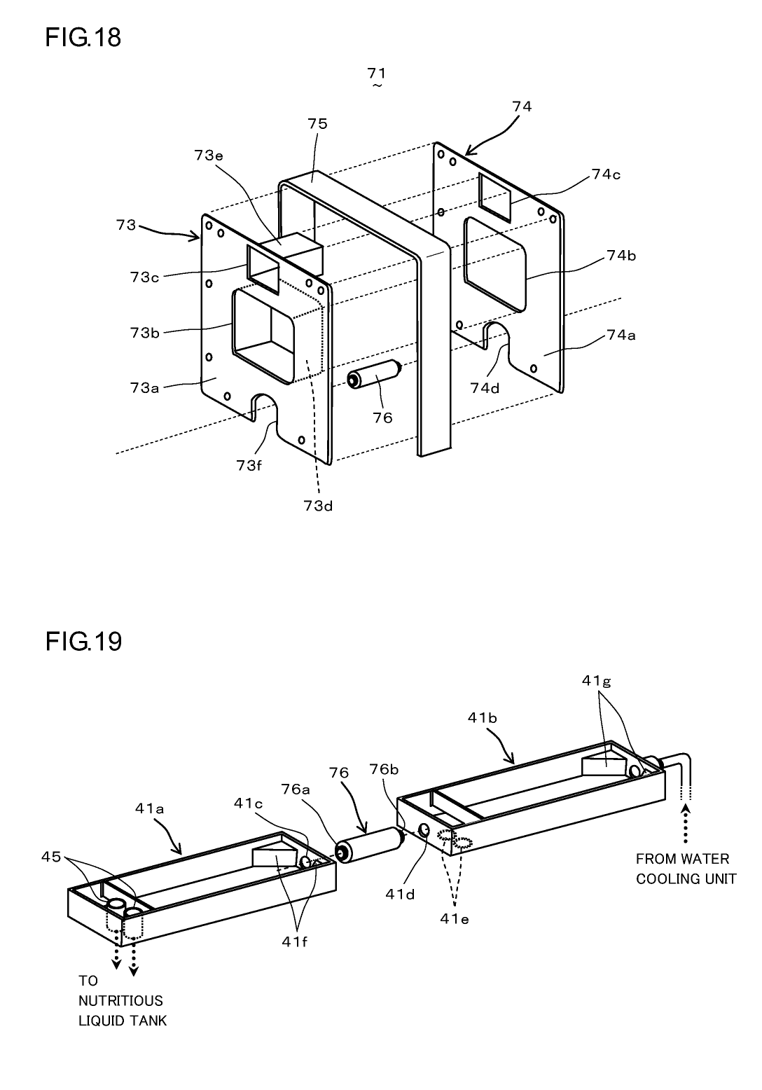

As shown in FIG. 18, the first connection unit 71 has a first side surface part 73 attached to a side surface of the growing chamber R1, a second side surface part 74 attached to a side surface of the growing chamber R2, and a blinder part 75 provided between these side surface parts 73 and 74. The first connection unit 71 also has a connection part 76 for connecting the hydroponic tanks 41a and 41b.

The first side surface part 73 has a supporting plate 73a having rectangular flat plate shape, a hole 73b provided in a position corresponding to the growing chamber R1 on the supporting plate 73a, and a hole 73c provided in a position corresponding to the light source storage room 30a on the supporting plate 73a. Moreover, the first side surface part 73 has a rectangular frame body 73d standing on a position corresponding to the hole 73b, a rectangular frame body 73e extending in the same direction with the frame body 73d and standing on a position corresponding to the hole 73c, and a hollow 73f for permitting a passage of the connection part 76. On the other hand, the second side surface part 74 has a supporting plate 74a having rectangular flat plate shape, a hole 74b provided on the supporting plate 74a in which the frame body 73d is fitted, a hole 74c provided on the supporting plate 74a in which the frame body 73e is fitted, and a hollow 74d for permitting a passage of the connection part 76. The first side surface part 73 is combined with the second side surface part 74 by fitting the frame bodies 73d and 73e to the holes 74b and 74c, respectively. The blinder part 75 is made up of a long and flat plate bent into a U shape and is held between the first side surface part 73 and the second side surface part 74 so as to mask the frame bodies 73d and 73e and the connection part 76.

As shown in FIG. 19, the connection part 76 has a tubular shape and has screw grooves 76a and 76b used for being screwed to the hydroponic tanks 41a and 41b on its both ends. The screw grooves 76a and 76b are screwed to screw holes 41c and 41d provided in side surfaces of the hydroponic tanks 41a and 41b, respectively, and thereby the connection part 76 connects the hydroponic tanks 41a and 41b to each other so that the water comes and goes between the hydroponic tanks 41a and 41b. Moreover, the drain passages 45 are removed from the hydroponic tank 41b, and stoppers 41e are attached to holes to which the drain passages 45 are originally attached. According to this configuration, the water supplied from the water cooling unit 9 to the end of the hydroponic tank 41b passes through the connection part 76 and is supplied to the hydroponic tank 41a, and afterwards, is discharged from the drain passage 45 in the end of the hydroponic tank 41a and then collected in the nutritious liquid tank. Current plates 41f and 41g are provided in the hydroponic tanks 41a and 41b to make the water flow constant.

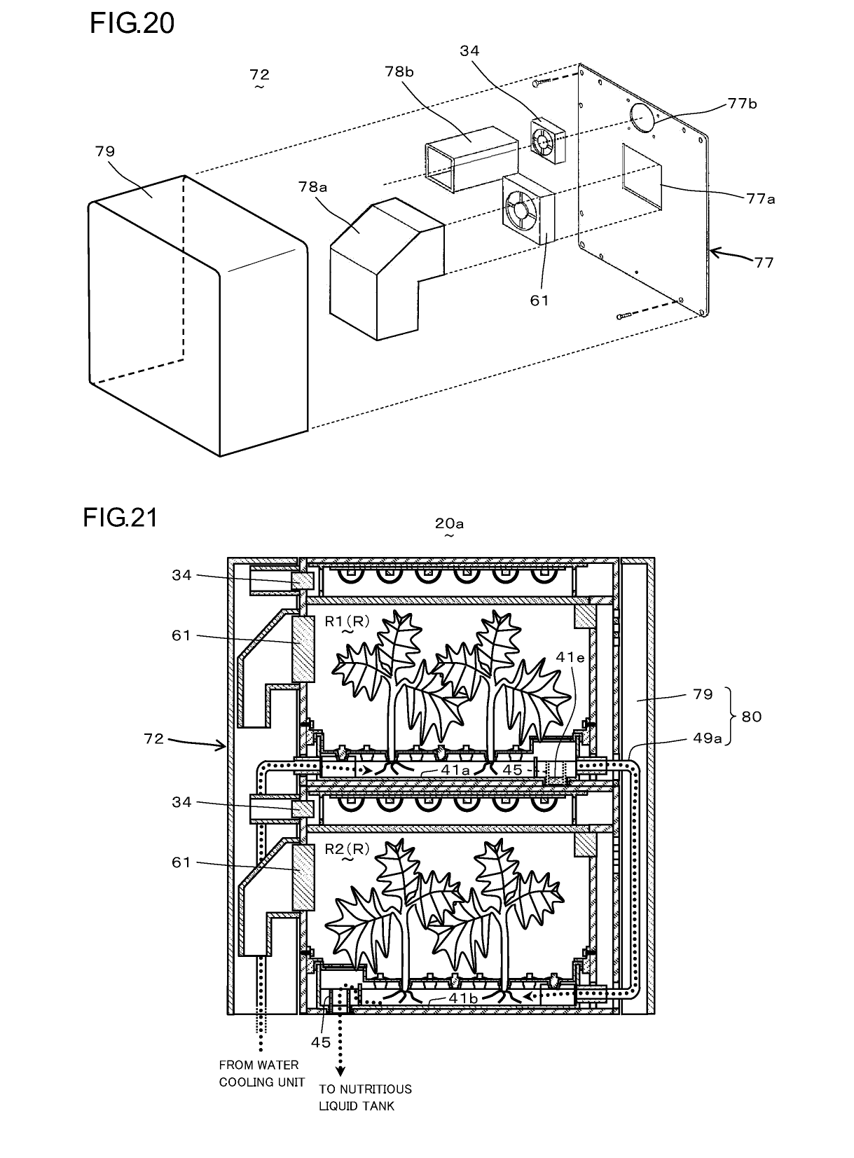

As shown in FIG. 20, the end unit 72 has a supporting plate 77 having rectangular flat plate shape. The supporting plate 77 is provided with holes 77a and 77b to which the intake unit 61 and the light source blower 34 are attached, respectively. The end unit 72 also has blower ducts 78a and 78b attached to the intake unit 61 and the light source blower 34, respectively, and a blinder part 79 which prevents the blower ducts 78a and 78b from being seen from the outside. The blinder part 79 has a rectangular box shape and is attached to the supporting plate 77 while including the blower ducts 78a and 78b.

Next, vertical connection of the plural hydroponic tanks 41 is described with reference to FIG. 21. A plant growing device 20a has two hydroponic tanks 41 which are arranged vertically and connected to each other using a second connection unit 80. Here, in order to distinguish the two hydroponic tanks 41, the hydroponic tank 41 located above is referred to as a hydroponic tank 41a and the hydroponic tank 41 located below is referred to as a hydroponic tank 41b. The growing chamber R1 provided with the hydroponic tank 41a and the growing chamber R2 provided with the hydroponic tank 41b are arranged so that the respective intake units 61 and the light source blowers 34 are placed in the same side. The respective intake units 61 and the light source blowers 34 of the growing chambers R1 and R2 are covered by the end unit 72 described above.

In the hydroponic tank 41a, the drain passage 45 is removed and the stopper 41e is attached to the hole to which the drain passage 45 is originally attached. The second connection unit 80 has a hose 49a and a blinder part 79 for masking the hose 49a so as not to be exposed to the outside. The hose 49a connects the hydroponic tank 41a and the hydroponic tank 41b to each other so that the water flows from the end of the hydroponic tank 41a, which is located near the stopper 41e, to the end of the hydroponic tank 41b, which is located opposite to the end where the drain passage 45 is provided. Accordingly, the water supplied from the water cooling unit 9 to the hydroponic tank 41a passes through the hose 49a and is supplied to the hydroponic tank 41b, and afterwards, is discharged from the drain passage 45 of the hydroponic tank 41b and then collected in the nutritious liquid tank.

According to the above plant growing device 20, the growing chambers R1 and R2, the light source storage rooms 30a and 30b, and the hydroponic tanks 41a and 41b can be horizontally connected to each other, respectively. In addition, according to the above plant growing device 20a, the hydroponic tanks 41a and 41b can be vertically connected to each other. Here, the connecting part or the ends of the growing chambers R1 and R2 are masked by the first connection unit 71, the second connection unit 80, or the end unit 72 and thus are not exposed to the outside. Accordingly, the plant growing devices 20 and 20a look neat and smart, so that it becomes possible to incorporate the plant growing devices 20 and 20a into furniture or the like and enjoy them as interiors. The number of the growing chambers R or the hydroponic tanks 41 connected to each other is not limited to two, and three or more growing chambers R or hydroponic tanks 41 may be connected to each other.

The plant growing device according to the present invention is not limited to the configuration of the above preferred embodiment, and various modifications are applicable. For example, the plant growing device does not necessarily have to contain the cultivation container, and the plant may be planted in the case directly. Moreover, the plant cultivation is not limited to the hydroponics, and the plant may be grown in the soil. The intake/exhaust mode and the circulation mode may be switched manually. It is also applicable that a CO₂ sensor is provided in the growing chamber to measure CO₂ concentration, and when the CO₂ concentration in the growing chamber becomes low, the mode is switched to the intake/exhaust mode. Moreover, in order to irradiate the plant with the light from the light source more efficiently, the light source may be arranged in an arch shape so as to cover the plant, or the light source may also be arranged not only above the plant but also on the side of the plant. Moreover, an air heating and cooling unit may also be provided to manage the temperature in the growing chamber more precisely. The personal computer may also be incorporated into the plant growing device to control the plant growing device. Furthermore, an electrostatic atomizer generating ion mist may also be provided to enhance the growth of the plant.

### DESCRIPTION OF THE NUMERALS

1, 10, 20, 20a plant growing device
18 germination room
21 door
25 hydroponic tank receiver
26 groove
27 vertical hole
3 light source
30, 30a, 30b light source storage room
31 white LED
32 red LED
33 waste heat hole
35 slit
36 waste heat passage
37 orthogonal part
38 parallel part
4 cultivation container
41, 41a, 41b hydroponic tank
42 bucket (nutritious liquid tank)
45 drain passage
45a aperture on upper side of drain passage
46 partition plate
46a opening of partition plate
5 human detection sensor
51 cover
52 insertion port
53 cap
56 fixture
6 ventilation unit
61 intake unit
62 exhaust unit
63 intake port
64 intake damper
65 blower
66 passage for guiding air to upstream side of blower
67 circulation damper
68 exhaust port
69 exhaust damper
71 first connection unit
80 second connection unit
8 pump
9 water cooling unit
D dew condensation water
P plant
R, R1, R2 growing chamber
W water

1. A plant growing device, comprising:
a growing chamber for storing a plant and
a ventilation unit for taking the air into and discharging the air from the growing chamber, wherein
the ventilation unit has an intake unit for taking the air from outside into the growing chamber and an exhaust unit provided in a position opposite to the intake unit for discharging the air from the growing chamber to the outside,
the intake unit has an intake port communicated with the outside, an intake damper for opening and closing the intake port, a blower for sending the air derived from the outside through the intake port to the growing chamber, a passage for guiding the air to an upstream side of the blower when the intake damper is closed to circulate the air in the growing chamber, and a circulation damper for opening and closing the passage,
the exhaust unit has an exhaust port communicated with the outside and an exhaust damper for opening and closing the exhaust port, and
the ventilation unit operates in either an intake/exhaust mode for taking the air into and discharging the air from the growing chamber by opening the intake damper and the exhaust damper and closing the circulation damper, or a circulation mode in which the air is circulated in the growing chamber by closing the intake damper and the exhaust damper and opening the circulation damper.

2. The plant growing device according to claim 1, wherein
the ventilation unit is controlled so that the intake/exhaust mode and the circulation mode are switched at every predetermined time.

3. The plant growing device according to claim 1, further comprising:
a light source provided in the growing chamber for irradiating the plant with light and
a human detection sensor for detecting human near the plant growing device, wherein
the light source has a white LED for emitting white light and a red LED for emitting red light, and
when the human detection sensor detects human, a radiant energy of red light emitted from the red LED is controlled to become half or less of that of white light emitted from the white LED, and when the human detection sensor does not detect human, the radiant energy of the red light is controlled to become half or more of that of the white light.

4. The plant growing device according to claim 3, further comprising:
a door provided on at least one side of side surfaces in a direction orthogonal to an air flow direction connecting the intake unit and the exhaust unit to open and close the growing chamber,
a light source storage room provided in an upper region of the growing chamber to store the light source, and
a waste heat hole communicated with the light source storage room to discharge waste heat generated by the light source to the outside, wherein
in the side surface where the door is provided, the waste heat hole is provided in a position masked by the door and thus not to be exposed to the outside when the door is closed.

5. The plant growing device according to claim 4, wherein
the light source storage room has a slit on at least one end of both ends in the air flow direction for radiating heat generated by the light source to the outside, and
the slit and the waste heat hole are connected by a waste heat passage, and the waste heat passage has an orthogonal part connected to the slit and extending in a direction orthogonal to the air flow direction and a parallel part connected to the orthogonal part and extending in a direction parallel to the air flow direction to be connected to the waste heat hole.

6. The plant growing device according to claim 3, further comprising:
a cultivation container in which the plant is planted, and
a distance between the cultivation container and the light source is adjustable.

7. The plant growing device according to claim 6, wherein
the cultivation container has a hydroponic tank for growing the plant hydroponically and a bucket located below the hydroponic tank so that the water flows from the hydroponic tank to the bucket, and further comprising:
a pump for pumping the water from the bucket to the hydroponic tank.

8. The plant growing device according to claim 7, wherein
a maximum water storage capacity of the bucket is larger than that of the hydroponic tank.

9. The plant growing device according to claim 7, further comprising:
a water cooling unit for cooling the water supplied to the hydroponic tank to adjust a water temperature.

10. The plant growing device according to claim 7, further comprising:
a light-shielding cover covered on an upper surface of the hydroponic tank, wherein
the cover has plural insertion ports into which the plant is inserted and a light-shielding caps which are detachably attached to the insertion ports.

11. The plant growing device according to claim 10, wherein
the cover is fixed to the hydroponic tank by a fixture attached to an inside of the growing chamber.

12. The plant growing device according to claim 10, wherein
a height from a bottom surface of the hydroponic tank to a lower surface of the insertion ports is substantially the same with a height of a surface of water pooled in the hydroponic tank.

13. The plant growing device according to claim 7, wherein
the hydroponic tank has a tubular drain passage which passes through a bottom of the hydroponic tank and extends in a vertical direction and a partition plate provided so as to surround an aperture on an upper side of the drain passage, and
the partition plate has an upper end higher than the aperture and an opening in a position lower than the aperture.

14. The plant growing device according to claim 13, wherein
the drain passage is detachable or height-adjustable with respect to the hydroponic tank.

15. The plant growing device according to claim 13, wherein
the hydroponic tank is placed on a hydroponic tank receiver constituting a bottom surface of the growing chamber,
the hydroponic tank receiver has a vertical hole through which the drain passage passes and a groove in which a dew condensation water generated on a surface of the hydroponic tank is pooled, and
the groove slopes down toward the vertical hole so that the dew condensation water flows into the vertical hole.

16. The plant growing device according to claim 1, further comprising:
a first connection unit for connecting the plural growing chambers arranged horizontally each other, wherein
the first connection unit connects the respective growing chambers so that the air flows between one growing chamber and the other growing chamber.

17. The plant growing device according to claim 7, further comprising:
a second connection unit for connecting the plural hydroponic tanks arranged vertically each other, wherein
the second connection unit connects the respective hydroponic tanks so that the water flows from one hydroponic tank into the other hydroponic tank.

18. The plant growing device according to claim 1, further comprising:
a germination room for sprouting a seed of a plant.

19. The plant growing device according to claim 2, further comprising:
a memory unit which stores information regarding a switching time of the intake/exhaust mode and the circulation mode, and
a ventilation unit controller which controls an operation of the ventilation unit based on the information stored in the memory unit.

20. The plant growing device according to claim 19, wherein
the information stored in the memory unit is supplied from an external server by an electric communication line.
